(19) United States
(12) Patent Application Publication
(10) Pub. No.: US 2008/0277249 A1
(43) Pub. Date: Nov. 13, 2008

(54) Circuit breaker with improved lock-off accessory

(76) Inventors: Antonio Zubieta, Monterrey (MX); John Winter, Cedar Rapids, IA (US); Fernanda Pineda, San Nicolas de los Garza (MX); Joni L. Orum, Atkins, IA (US)

Correspondence Address: SCHNEIDER ELECTRIC / SQUARE D COMPANY;LEGAL DEPT. - I.P. GROUP (NP), 1415 S. ROSELLE ROAD, PALATINE, IL, 60067, US

(21) Appl. No.: 11/801,673

(22) Filed: May 10, 2007

(51) Int. Cl. H01H 9/28

(52) U.S. Cl. 200/43.11

(57) ABSTRACT

A circuit breaker comprises a housing containing a trip mechanism, a handle coupled to the trip mechanism and movable between on and off positions, and a lock-off mechanism capable of holding the handle in its off position. The lock-off mechanism includes a base member adapted to be mounted on the circuit breaker housing adjacent the movable handle. A slide is mounted on the base member for movement to an advanced position in which a portion of the slide projects into the path of movement of the breaker handle for engaging the handle and blocks movement of the handle from the “off” position to the “on” position. In the retracted position of the slide, the path of movement of the handle is unobstructed by the slide. A key-operated lock is also mounted on the base, and a lock shaft is coupled to the lock and mounted for movement to a locked position in which the shaft engages the slide when the slide is in its advanced position to block retracting movement of the slide, thereby locking the breaker handle in its “off” position. In the unlocked position of the lock shaft, movement of the slide is unobstructed by the shaft, but the slide interferes with advancing movement of the lock shaft, thereby preventing the lock shaft from moving to its advanced position.

### FIELD OF THE INVENTION

The present invention relates to a circuit breaker lock-off accessory that provides the function of locking “off” the handle of a circuit breaker so that it cannot be turned to the “on” position.

### BACKGROUND OF THE INVENTION

It is frequently necessary to ensure that electrical equipment cannot be operated, e.g., while maintenance work is being carried out. It is essential to ensure that circuit breakers associated with the equipment are secured in the “off” position, to protect against inadvertent operation of the breaker that could injure personnel or damage the equipment. A variety of methods have been used to secure the operating handles of circuit breakers in the “off” position, such as by locking a cabinet within which the circuit breakers are housed, or providing a locking tab mounted within a recess of a multi-pole circuit breaker housing. However, such locking tabs can be difficult to operate, and may be suitable only for multi-pole devices. It is also known to provide a locking attachment that may be screwed onto the circuit breaker housing. However, such locking attachments may require disconnection of the circuit breaker from the circuit before they can be mounted.

### SUMMARY OF THE INVENTION

According to one embodiment of the present invention, a circuit breaker comprises a housing containing a trip mechanism, a handle coupled to the trip mechanism and movable between “on” and “off” positions, and a lock-off mechanism capable of holding the handle in the “off” position. The lock-off mechanism includes a base member adapted to be mounted on the circuit breaker housing adjacent the movable handle. A slide is mounted on the base member for movement to an advanced position in which a portion of the slide projects into the path of movement of the breaker handle for engaging the handle and blocks movement of the handle from the “off” position to the “on” position. In the retracted position of the slide, the path of movement of the handle is unobstructed by the slide. A key-operated lock is also mounted on the base, and a lock shaft is coupled to the lock and mounted for movement to a locked position in which the shaft engages the slide when the slide is in its advanced position to block retracting movement of the slide, thereby locking the breaker handle in its “off” position. In the unlocked position of the lock shaft, movement of the slide is unobstructed by the shaft.

In one specific embodiment, the key-operated lock comprises a pair of locks, operated by different keys, for moving the lock shaft back and forth between the locked and unlocked positions, and the movement of the lock shaft to the unlocked position requires the unlocking of both locks.

In one implementation, the portion of the slide that projects into the path of movement of the breaker handle is elongated in the direction of movement of the handle so that the projecting portion of the slide abuts a side surface of the handle when the handle is in any position other than its “off” position, thereby preventing movement of the slide to its advance position when the handle is not in its “off” position.

The foregoing and additional aspects of the present invention will be apparent to those of ordinary skill in the art in view of the detailed description of various embodiments, which is made with reference to the drawings, a brief description of which is provided next.

### BRIEF DESCRIPTION OF THE DRAWINGS

The foregoing and other advantages of the invention will become apparent upon reading the following detailed description and upon reference to the drawings.

FIG. 1 is a front perspective view of a circuit breaker equipped with one embodiment of an improved lock-off device, with the breaker handle in the “off” position and with the lock-off device in the unlocked position.

FIG. 2 is a top plan view of the circuit breaker shown in FIG. 1, with the breaker handle in the “off” position and with the lock-off device in the locked position.

FIG. 3 is an enlarged exploded perspective view of the lock-off device shown in FIGS. 1-3, prior to installation on the circuit breaker, and in the unlocked position, with the lock-off device in the unlocked condition.

FIG. 4 is a reduced perspective view of the lock-off device shown in FIG. 3, with the lock-off device in the unlocked condition.

FIG. 5 is a top plan view of the lock-off device shown in FIG. 4, showing the unlocked condition in solid lines and the unlocked condition in broken lines.

FIG. 6 is a side elevation of the lock-off device shown in FIG. 4.

FIG. 7 is an end elevation of the lock-off device shown in FIG. 4.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE ILLUSTRATED EMBODIMENTS

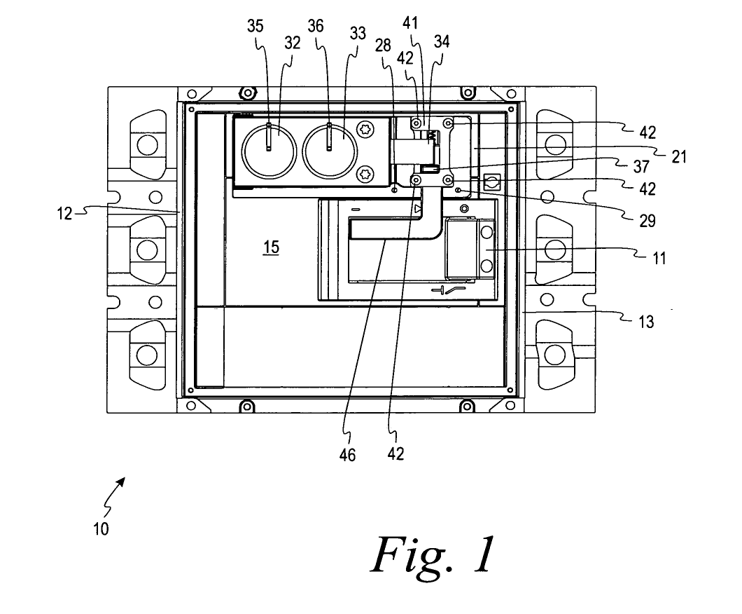

Turning now to the drawings and referring first to FIG. 1, a circuit breaker 10 has a handle 11 movable between an “off” position, shown in solid lines in FIG. 1, and an “on” position, shown in broken lines in FIG. 1. The power lines controlled by the breaker are connected to “line” and “load” terminals 12 and 13 accessible at opposite end portions 12 and 13 of the breaker housing 14. The power line is closed when the breaker is “on” and open when the breaker is “off.” To prevent inadvertent or unauthorized movement of the breaker handle 11 from the “off” position to the “on” position, it is common to provide a lock-off device to lock the handle 11 in the “off” position.

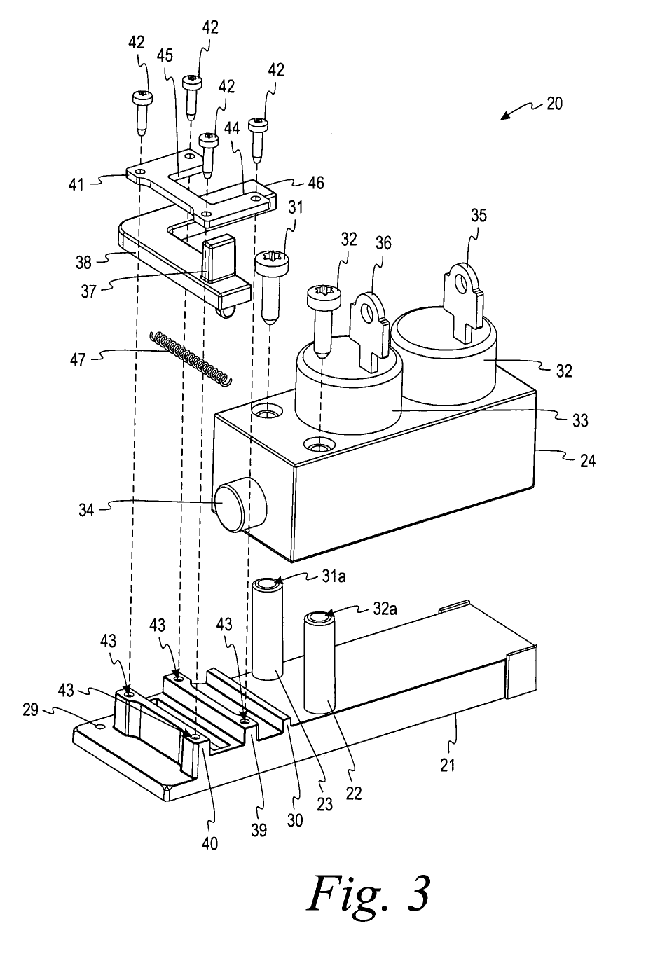

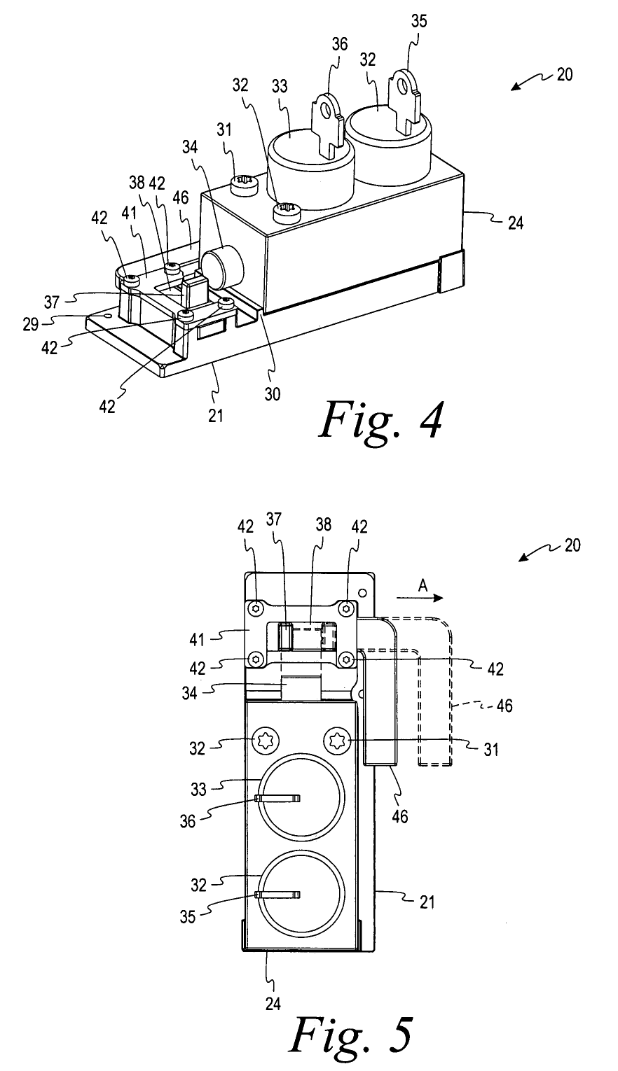

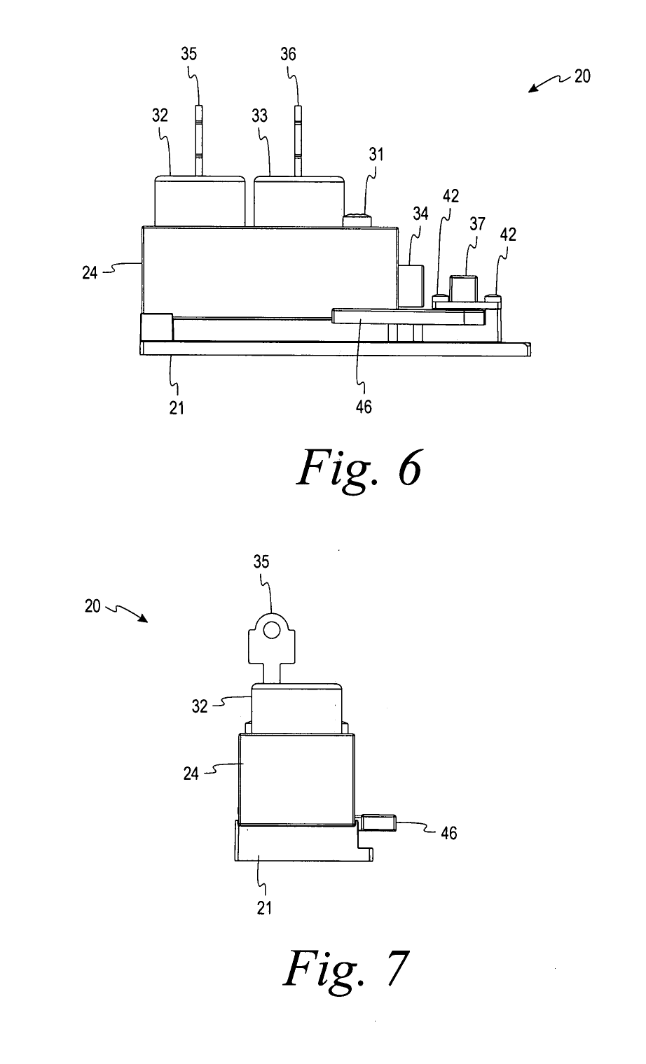

The breaker 10 shown in FIG. 1 is equipped with a lock-off device 20, which is shown detached from the breaker in FIGS. 3-7. This lock-off device 20 includes a base 21 forming a pair of mounting posts 22 and 23 (see FIG. 3) for receiving a key interlock unit 24. The base 21 is firmly attached to the cover 15 of the circuit breaker 10 by two tamper-resistant screws 28 and 29 passing through the base 21 and threaded into a pair of mating threaded sockets in the cover 15, and a third tamper-resistant screw (not shown) passing through the cover 15 from the inside surface and threaded into a mating threaded socket in the lower surface of the base 21. Suitable tamper-resistant screws are star screws that have a post in the center of the star-shaped socket in the screw head, such as tamper-resistant “TORX” brand screws available from Textron Fastening Systems.

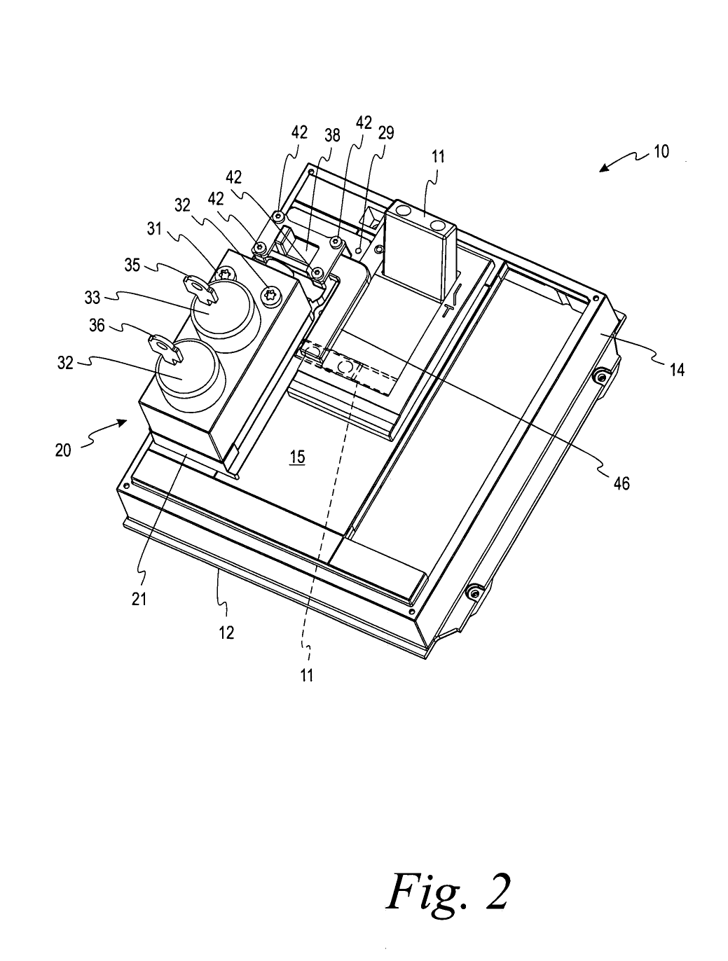

The key interlock unit 24 is mounted against a positioning rib 30 on the upper surface of the base 21 and is telescoped over the mounting posts 22 and 23. A pair of tamper-resistant screws 31 and 32 pass through the cover of the unit 24 and are threaded into a pair of mating threaded sockets in the upper ends of the mounting posts 22 and 23. The key interlock unit 24 includes a pair of key-operated cylinder locks 32 and 33 for controlling the axial movement of a lock shaft 34 that extends parallel to the surface of the base 21. The shaft 34 is coupled to the two cylinder locks 32 and 33, and can be advanced and retracted by turning the keys 35 and 36 in the respective locks 32 and 33. The advanced position of the shaft 34 is its locking position in which the shaft 34 engages the outboard surface of a tab 37 projecting from a slide 38 when the slide is in its advanced position to block retracting movement of the slide. The slide 38 is the element that locks the breaker handle 11 in its “off” position, by blocking movement of the breaker handle 11 away from its “off” position (see FIGS. 2 and 5). Both keys 35 and 36 must be turned in the clockwise direction to move the slide 38 to its advanced position. The shaft 34 can be locked in its advanced position by turning the two keys 35 and 36 in the counterclockwise direction and then removing the keys from their respective locks. The retracted position of the locking shaft is its unlocked position in which movement of the slide 38 is unobstructed by the locking shaft, permitting the slide to be retracted to unlock the breaker handle 11 (see FIGS. 1, 4 and 5).

The slide 38 is mounted for sliding movement in a channel formed by a pair of spaced ribs 39 and 40 extending upwardly from the top surface of the base 21. The slide 38 is captured in the channel between the ribs 39 and 40 by a C-shaped steel bracket 41 that is fastened to the ribs by four tamper-resistant screws 42 passing through the bracket 41 and threaded into mating threaded sockets 43 in the top surfaces of the ribs 39 and 40. The slide tab 37 extends above the bracket 41 so that the opposed edges of the two end legs 44 and 45 of the C-shaped bracket limit the range of reciprocating movement of the slide 38, while also holding the slide down between the two ribs 39 and 40. The slide 38 moves between (1) an advanced position in which a portion of the slide projects into the path of movement of the handle 11 to engage the handle and block movement of the handle from the “off” position to the “on” position, and (2) a retracted position in which the path of movement of the handle 11 is unobstructed by the slide, permitting the handle to be moved to its “on” position.

The slide 38 is L-shaped, and one leg 46 of the L extends into the path of the breaker handle 11 when the slide 38 is in its advanced position (shown in FIG. 3) and the handle 11 is in its “off” position (also shown in FIG. 3). The slide can be locked in this advanced position by extending the locking shaft 34 to its advanced position where it blocks movement of the slide 38 by engaging the slide tab 37, as shown in FIGS. 2 and 5. This holds leg 46 of the slide 38 firmly in its advanced position to block any movement of the breaker handle 11 away from its “off” position. To unlock the breaker handle 11, the locking shaft 34 is retracted toward the cylinder locks 32 and 33 until the shaft clears the slide tab 37, at which point the slide 38 is automatically moved to its retracted position (shown in FIG. 2) by a biasing spring 47 (see FIG. 3) coupled between the bottom of the slide 38 and the base 21. Once the slide 38 is retracted, the handle 11 is free to be moved to its “on” position.

Thus, the handle 11 is locked in its “off” position as long as the locking shaft 34 remains in its advanced position, thereby ensuring that only authorized personnel who control the cylinder locks 32 and 33 can unlock the lock-off device to permit the breaker handle 11 to be moved to its “on” position. The lock shaft can be retracted only by unlocking both of the cylinder locks, thereby requiring two authorized people to unlock the breaker, assuming the two keys 35 and 36 are in the custody of two different people. When the slide 38 and the lock shaft 34 are both in their retracted positions, the slide tab 37 interferes with advancing movement of the lock shaft, thereby preventing the lock shaft from moving to its advanced position, which in turn prevents the keys 35 and 36 from being removed from their respective locks 32 and 33.

The length of the leg 46 of the slide 38 prevents the slide from being advanced when the breaker handle is in any position other than its “off” position. When the handle 11 is in any other position, the slide 38 cannot be advanced because the leg 46 of the slide will simply abut a side surface of the handle 11, preventing any advancing movement of the slide 38 (see FIGS. 1, 2 and 5). The lock keys 35 and 36 can be removed from the cylinder locks only when the lock shaft is in its advanced position, and thus cannot be removed from the cylinder locks 32 and 33 when the handle 11 is in any position other than its “off” position.

The illustrative lock-off device can be easily mounted on a circuit breaker with only the few tamper-resistant screws described above, and thus can be installed with minimal time and expense. Although the illustrative device utilizes two different locks and keys for extra security, the device can be made with only a single lock and key if a lower level of security is acceptable. This lock-off device is easy for the customer to use.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. A lock-off mechanism for a circuit breaker having a housing containing a trip mechanism and a handle coupled to said trip mechanism and movable between on and off positions, said mechanism comprising
a base member adapted to be mounted on said circuit breaker housing adjacent the movable handle,
a slide mounted on said base member for movement between an advanced position in which a portion of said slide projects into the path of movement of said handle for engaging said handle and blocks movement of said handle from the “off” position to the “on” position, and a retracted position in which the path of movement of said handle is unobstructed by said slide,
a key-operated lock mounted on said base, and
a lock shaft coupled to said lock and mounted for movement back and forth between a locked position in which said shaft engages said slide when said slide is in its advanced position to block retracting movement of said slide, thereby locking said breaker handle in its “off” position, and an unlocked position in which movement of said slide is unobstructed by said shaft.

2. The lock-off mechanism of claim 1 which includes a pair of key-operated locks, operated by different keys, for moving said lock shaft back and forth between said locked and unlocked positions, the movement of said lock shaft to said unlocked position requiring the unlocking of both of said locks.

3. The lock-off mechanism of claim 1 in which the portion of said slide that projects into the path of movement of said handle is elongated in the direction of movement of said handle so that said projecting portion of said slide abuts a side surface of said handle when the handle is in any position other than its “off” position, thereby preventing movement of said slide to its advanced position when said handle is not in its “off” position.

4. The lock-off mechanism of claim 1 which includes a spring biasing said slide toward its retracted position, so that said slide is automatically retracted upon release from said locking shaft.

5. The lock-off mechanism of claim 1 in which said base member forms a channel for receiving a portion of said slide, and further including a bracket attached to said base member to retain said slide in said channel and to limit the range of sliding movement of said slide within said channel.

6. The lock-off mechanism of claim 5 in which said portion of said slide received in said channel forms an upwardly extending tab, and said lock shaft engages the surface of said tab facing away from said breaker handle when said shaft is in its locked position.

7. The lock-off mechanism of claim 1 in which the direction of movement of said slide is perpendicular to the direction of movement of said breaker handle.

8. A circuit breaker comprising
a housing containing a trip mechanism and a handle coupled to said trip mechanism and movable between on and off positions, and
a lock-off mechanism including
a base member mounted on said circuit breaker housing adjacent the movable handle,
a slide mounted on said base member for movement between an advanced position in which a portion of said slide projects into the path of movement of said handle for engaging said handle and blocks movement of said handle from the “off” position to the “on” position, and a retracted position in which the path of movement of said handle is unobstructed by said slide,
a key-operated lock mounted on said base, and
a lock shaft coupled to said lock and mounted for movement back and forth between a locked position in which said shaft engages said slide when said slide is in its advanced position to block retracting movement of said slide, thereby locking said breaker handle in its “off” position, and an unlocked position in which movement of said slide is unobstructed by said shaft.

9. The circuit breaker of claim 8 in which said lock-off mechanism includes a pair of key-operated locks, operated by different keys, for moving said lock shaft back and forth between said locked and unlocked positions, the movement of said lock shaft to said unlocked position requiring the unlocking of both of said locks.

10. The circuit breaker of claim 8 in which the portion of said slide that projects into the path of movement of said handle is elongated in the direction of movement of said handle so that said projecting portion of said slide abuts a side surface of said handle when the handle is in any position other than its “off” position, thereby preventing movement of said slide to its advanced position when said handle is not in its “off” position.

11. The circuit breaker of claim 8 in which said lock-off mechanism includes a spring biasing said slide toward its retracted position, so that said slide is automatically retracted upon release from said locking shaft.

12. The circuit breaker of claim 8 in which said base member forms a channel for receiving a portion of said slide, and further including a bracket attached to said base member to retain said slide in said channel and to limit the range of sliding movement of said slide within said channel.

13. The circuit breaker of claim 12 in which said portion of said slide received in said channel forms an upwardly extending tab, and said lock shaft engages the surface of said tab facing away from said breaker handle when said shaft is in its locked position.

14. The circuit breaker of claim 12 in which said tab interferes with advancing movement of said lock shaft when said shaft is in its locked position and said slide is retracted position, thereby preventing said lock shaft from moving to its advanced position.

15. The circuit breaker of claim 8 in which the direction of movement of said slide is perpendicular to the direction of movement of said breaker handle.

16. The circuit breaker of claim 8 in which said key that operates said lock can be removed from said lock only when said lock shaft is in its locked position.
